(19) United States
(12) Patent Application Publication
(10) Pub. No.: US 2004/0078422 A1
(43) Pub. Date: Apr. 22, 2004

(54) Detecting and blocking spoofed Web login pages

(76) Inventor: Christopher Newell Toomey, Cupertino, CA (US)

Correspondence Address: GLENN PATENT GROUP, 3475 EDISON WAY, SUITE L, MENLO PARK, CA, 94025, US

(21) Appl. No.: 10/273,236

(22) Filed: Oct. 17, 2002

(51) Int. Cl. G06F 15/16

(52) U.S. Cl. 709/202

(57) ABSTRACT

A method and apparatus is provided for detecting spoofed login pages and determining and executing an appropriate course of action to prevent spoofers from obtaining users' login IDs and passwords via the spoofed login pages.

### BACKGROUND OF THE INVENTION

1. Technical Field

The invention relates generally to Internet based user authentication technology. More particularly, the invention relates to user authentication via login pages deployed on the World Wide Web and accessed by the user via a Web browser, more specifically, detecting spoofed login Web login pages and determining and executing a course of action to block them.

2. Description of the Prior Art

The use of World Wide Web (Web) browsers and personal applications, such as email and instant messaging (IM) are widespread. A negative consequence of the proliferation of the use of email and IM is that spoofers have taken to invading and exploiting innocent users having such personal accounts.

As an example, consider a typical user of a large ISP, such as America Online, Inc. (AOL), reading his or her email from the email application provided within the AOL client. In this example, the spoofer sends an email pretending to be an entity at AOL. The spoofer's email indicates that the spoofer is from AOL account services and that there has been some kind of problem. The spoofer posing as an AOL entity tells the innocent user that he or she needs to reset the password to their AOL account. The spoofer provides a hyperlink in the email message body intended for the user to click. The spoofer can just as easily contact an innocent user through other applications, such as an instant messaging, as well. Essentially, the spoofer is trying to get the innocent user to click on a link which is going to take the user to a web page that looks like an AOL Web login page, but in fact is the spoofer's Web page. That is, the spoofer wants the user to visit the spoofer's Web page or respond to the spoofer's IM, and then to provide the spoofer with the innocent user's user ID and/or password. The spoofer is now in a position to use the user's ID and password to hijack the user's account.

More specifically, when the innocent user clicks on the link in the spoofer's email, a Web browser opens to a new page. This new page is made to look like the ISP's page, such as an AOL Web page, because spoofers misuse the images and other content from the ISP's Web login page. Then somewhere within that spoofer's Web page, the user is asked for the user's screen name, or, more generally, login ID, and password. Typically, the spoofer's Web page uses a Web form to gather such information. When the user fills out and submits the Web form, it gets sent to the spoofer's server.

It has been found that many of the large ISPs are targeted for such type of invasions a lot of the time. One reason a spoofer desires such information from a user is that it is used to send spam. Typically, to send spam, one needs access to a lot of accounts because such accounts typically are shut down when one starts sending spam. To get around creating accounts soon to be dissolved, spoofers wanting to send spam get an innocent user's ID and password and immediately logs into the associated account. While logged onto the innocent user's account, a spoofer sends out spam. By the time the misuse is discovered and the spoofers are subsequently shut down, they have already sent out a large amount of spam. The spoofers then move on to the next unsuspected account.

It has been found that sometimes spoofers send spam from their own servers but, in this case put in a phony ISP, e.g. AOL, return address because doing so is easy for the spoofer and fools users into a false sense of security.

It would be advantageous to differentiate a spoofer's Web page, a spoofed Web page, from a legitimate ISP's Web page, such as an AOL Web page, that is safe for a user actually to log into. It would be further advantageous to perform subsequent actions to protect the innocent user after detection and identification of such spoofed Web pages.

### SUMMARY OF THE INVENTION

A method and apparatus is provided for detecting spoofed login pages and determining and executing an appropriate course of action to prevent spoofers from obtaining users' login IDs and passwords via the spoofed login pages.

### BRIEF DESCRIPTION OF THE DRAWINGS

FIG. 1 is a schematic diagram including components of the invention and their respective relationships; and

FIG. 2 is a schematic diagram illustrating the agent having API functionality to communicate with a communication application containing a spoofer's message, with the Web browser, and with the parent client application, according to the invention.

### DETAILED DESCRIPTION OF THE INVENTION

A method and apparatus is provided for detecting spoofed login pages and determining and executing an appropriate course of action to prevent spoofers from obtaining users' login IDs and passwords via the spoofed login pages.

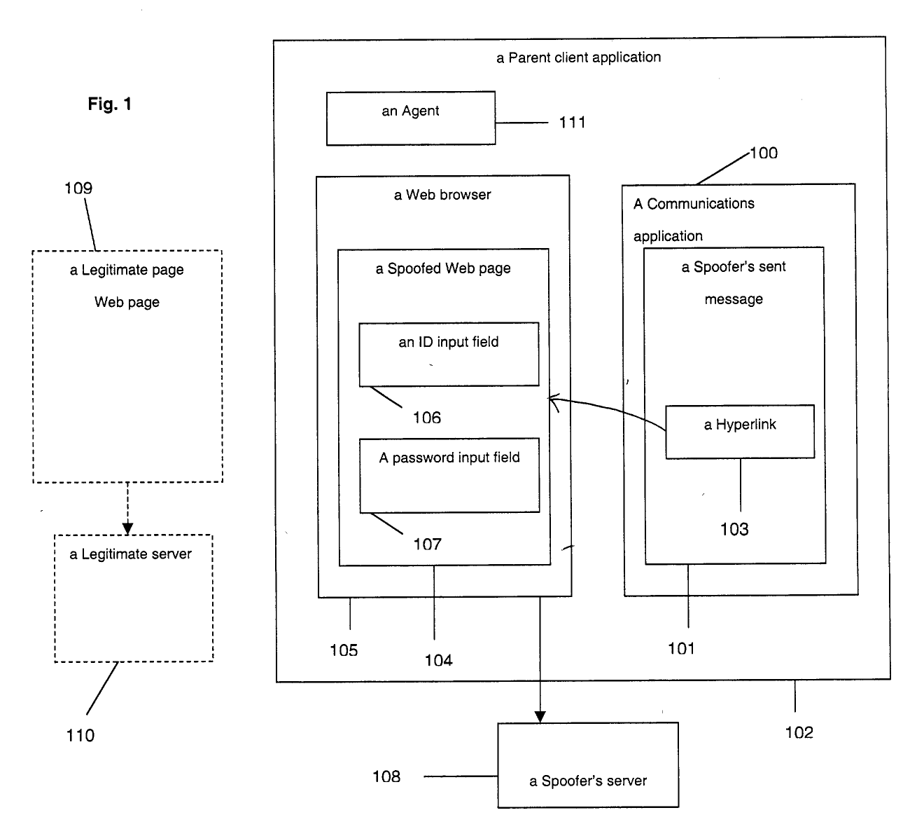

The preferred embodiment of the invention is described with reference to FIG. 1, a schematic diagram including components of the invention and their respective relationships. It should be appreciated that components of the invention can be implemented in software as well as hardware. Therefore, for simplicity, components of the invention are described herein below in software modular form, but equally represent hardware component form in the discussion herein.

A spoofer sends a message 101 to a client application 102. The message 101 is opened by a client communications application 100, such as an email application, an instant messaging application, and the like. The spoofer's message indicates to a user that it is from the user's ISP, such as from AOL. The spoofer is trying to fool the user to believing the message is from the user's ISP. The message 101 contains a hyperlink 103 that leads to a spoofed Web page. Or, the message 101 equally contains a hyperlink that leads through a chain of hyperlinks to its destination spoofed Web page. That is, a spoofer may redirect a user through multiple Web pages until the user reaches the spoofed Web page. The content of the message 101 prompts the user to click on the hyperlink 103, which opens a Web page 104 in a Web browser 105.

In this scenario, the opened Web page 104 is a spoofed login Web page. The user was tricked into believing he or she needs to provide his or her login information to the Web page 104. The spoofed Web page 104 contains an input form somewhere within the page. The input form fields typically accept either the user's login ID 106 or the user's password 107, and most typically both, but could equally accept any type of user credential data. It should be appreciated that such input form fields may have labels that are misnomers, i.e. not labeled login ID and password, to try to disguise that they are trying to dupe the user.

It should be appreciated that the spoofer's message 101 prompting the opening of the spoofed Web page 104 is sent via email, via instant messaging, via another Web page, and the like. In other words, the spoofer's message 101 is sent via any viable communication protocol, comprising but not limited to email, instant messaging, Web pages, and the like.

When the user enters ID data and/or password data into the input fields 106 and 107, and submits the spoofed Web page 104, the spoofed Web page containing user credential data is received by the spoofer's server to do what it wants with the user's credential data.

The preferred embodiment of the invention distinguishes a spoofed Web page 104 from a legitimate Web page 109, which, if and when submitted, is sent to a legitimate server 110, such as the user's ISP. Furthermore, the invention suggests possible courses of action when a spoofed page is found.

The invention is flexible in that the agent component (agent) 111 is adaptable to be implemented in a variety of ways. Following are examples of possible implementations. In one preferred embodiment of the invention, the agent component (agent) 111 is embedded in the client application 102. In an equally preferred embodiment, the agent 111 is embedded in the opened, standalone or non-standalone Web browser 105. In another equally preferred embodiment of the invention, the agent 111 is embedded in a Web proxy server (or another server that communicates with the Web proxy server) on a host computer operated by the ISP. In other equally preferred embodiments of the invention, the agent is embedded in the message application, is a separate client application, is embedded in a client operating system, and is embedded in a server application.

The agent 111 is invisible to the user. Essentially, the agent 111 examines the newly opened Web page 104 in the Web browser 105 and gathers any data it desires from the Web page 104. That is, the agent 111 has functionality to check on data within the Web page 104 and to intercede between the user's action, the user believing it is interacting with a legitimate Web page, and with a spoofed Web page, if necessary or desirable. The agent 111 also contains functionality to examine other contextual data, e.g. the series of URLs through which the user navigated from the spoofer message to the spoofed web page, the sender and content of the spoofer message, etc.

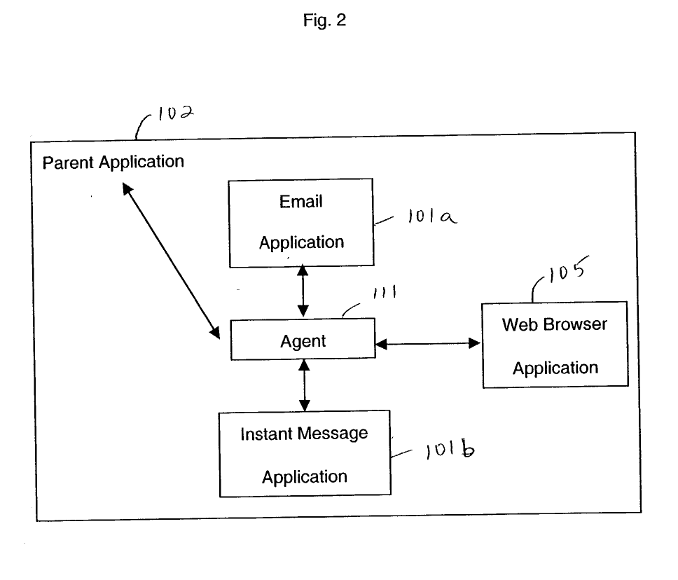

FIG. 2 is a schematic diagram illustrating an agent 111 having functionality to communicate with the ISP's message application, e.g. 101a and 101b, with the Web browser application 105, and with a parent client application 102, according to the invention. It should be appreciated that FIG. 2 is by example only. For example, the parent client application 102 is optional, because the agent can be embedded in a standalone browser. Also, the spoofer's message can be sent via a separate Web page, etc. Referring to FIG. 2, the agent 111, according to the preferred embodiment of the invention, is capable of communication through application programming interface (API) protocols to a spoofer's email application 101a, through application programming interface (API) protocols to the instant message application (IM) 101b, through application programming interface (API) protocols to the Web browser application 105, and through application programming interface (API) protocols to the client or parent application 102, if any. If the agent 111 decides to take some sort of action to prevent spoofing, it sends commands through the APIs to the appropriate entity, such as ISP's message application, Web browser application, and/or client application.

The agent is embedded with capture prevention logic, preferably in the form of programmable code, for detecting if an opened Web page is a spoofed Web page, also referred to as a capture page, and what course of action, referred to as capture disarming, if any, is required.

### Capture Prevention

The preferred embodiment of the invention provides capture prevention capability, where capture refers to the capturing of a user's credentials. Capture prevention comprises first detecting a Web page as a capture page, and second disarming such page in such a way as to prevent current and/or future credential capturing.

The preferred embodiment of the invention provides an agent that: is notified by a Web browser each time a new Web page is loaded into the browser; has access to and ability to modify the Document Object Model for the current Web page; has access to other context in the browser, such as the URL history, the user's cookies, etc.; and has access to and ability to override navigation requests, e.g. to other Web pages, made to the browser.

### Exemplary Capture Page Detection Techniques

Below are suggested techniques, which can be used in combination effectively, for identifying capture pages (spoofed Web pages) according to the preferred embodiment of the invention. It should be appreciated that such list of techniques is by no means exhaustive and is meant by example only.

### Detecting Login ID and Password Entry by end Users (Keystroke Monitoring)

The preferred embodiment of the invention leverages the agent's platform, which preferably provides Javascript access to and manipulation of a Web page's Document Object Model for attaching to form fields on Web pages keystroke-monitoring event handlers, which can detect user entry of login ID and/or password.

The preferred embodiment of the invention allows flexibility in implementation. For example, details as to the implementation of the following can vary: 1) to which Web pages should the detection instrumentation be applied to achieve a right balance between spoof detection and false alarming and performance degradation; 2) whether detecting login ID entry along with other contextual clues (as described herein below) obviates the need for detecting password entry, or whether password entry detection is necessary, as well; 3) if password detection is necessary, how to get the password or some derivative of it, e.g. one-way hash, to the client for use by the agent; and 4) what the correct response is when capture is detected (see prevention techniques herein below).

### Automated Contextual Analysis of Pages

The agent applies heuristics to score a page's probability of being a capture page. Then, appropriate actions for a score are taken by the agent, e.g. block the page display if the agent has a level of confidence that the page is a spoof page. Another action is to send the page and score to an anti-spoofing manager, typically via client-server communication initiated by the agent, for further analysis. Such further analysis includes measuring if the score is higher or lower than a predetermined threshold value. Some possible contextual clues include, but are by no means limited to the following:

1) was the Web page navigated to from an email hyperlink, or more generally, how far in terms of links and/or redirects is the Web page from the last email hyperlink, because most spoof login Web pages are reached by users clicking on links in spam email sent by spoofers;

2) what host is serving the Web page. Legitimate hosts for AOL login pages are, for example, my.screenname.aol.com and ureg.netscape.com, but not, for example, aolmail.1300.net.

3) whether or not there is an obfuscating “userid:password@” prefix before the host name in the URL, such as, for example:

http://netmail.aol.com-09120909190092_aolmail.login.9298198892_aol % 3Dtrue.290092.198981.aolnetmail % 3Dture.902909802892.newmsg.90390390213989823@aolmail.1300.net/;

4) does the page contain a form with input elements that could be used for login ID+password, and

5) statistics from end users who see an interactive warning and/or confirmation dialog about a page being a possible spoof and are given ability to proceed (not spoof) or cancel (spoof).

### Human Analysis of Pages

Another preferred embodiment provides applying some level of staffing to the anti-spoofing problem for complementing automated spoof page detection. For example, as described herein above, in combination with automated contextual analysis filtering out likely spoof pages and sending such pages to humans for further assessment. In one implementation, possible spoof pages are reported by ISP employees or by end users via keywords. Then the ISP staffers investigate, and when they confirm pages are spoof pages, they take action to disable such pages, such as, for example, emailing the ISP hosting such page and requesting that the page be removed.

Supposing that capture pages are detected using techniques or combinations of techniques such as those above. Then, the natural next logical problem to be solved is how to prevent such capture pages from capturing login credentials, and the like. That is, the question is how to disarm such capture pages.

### Exemplary Capture Page Disarming Techniques

Below are suggested techniques, which can be used in combination effectively, for disarming capture pages according to the preferred embodiment of the invention. It should be appreciated that such list of techniques is by no means exhaustive and is meant by example only.

### Block or Disable Pages

The preferred embodiment of the invention automatically prevents user access to spoof pages via blocking them altogether in a Web proxy server and/or in the client application or Web browser application by the agent, or by disabling them, for example, by blocking user input into such pages via the agent. Another technique is maintaining an explicit list of URLs to block and blocking only those on the list. In the case of spammers easily varying the URL per email to defeat such a scheme, then sophisticated techniques are provided, such as maintaining a list of blocked URL domains or URL regular expressions, or, in contrast, having a list of allowed domains and/or regular expressions and blocking others. The invention is flexible to incorporate many other types of approaches.

### Request ISPs and/or Site Owners to Remove Pages

Such technique is discussed herein above.

### Interactive Warning and/or Confirmation Dialog

Such technique is applicable in conjunction with a detection technique that was uncertain about a given page being a spoof page, e.g. in conjunction with an automated scoring technique. According to this technique, the end user decides whether or not a page is a spoof page. One implementation is providing a warning, such as a warning dialog, to the end user in which warning is provided additional information for the end user making a decision. Then, the end user either explicitly confirms that the page is legitimate before proceeding to open the page, or cancels to abort opening the page. Furthermore, in another embodiment of the invention, statistics as to the proceed rates and/or the abort rates are fed back into a page's spoof scoring analysis.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method of detecting a spoofed Web page over a network, said method comprising the steps of:
obtaining a spoofer's message, said spoofer's message containing a hyperlink, which, when clicked opens a Web page within a Web browser;I
providing an agent for inspecting contextual data associated with said spoofer's message; and
said agent using said contextual data for determining whether or not said Web page is a spoofed Web page.

2. The method of claim 1, wherein said contextual data comprises content of said Web page, and sender information and content of said spoofer's message.

3. The method of claim 1, wherein said agent is embedded in a client application, said client application containing said opened Web browser and said message application.

4. The method of claim 1, wherein said agent is embedded in said Web browser.

5. The method of claim 1, wherein said agent is embedded in said message application.

6. The method of claim 1, wherein said agent is a separate client application.

7. The method of claim 1, wherein said agent is embedded in a client operating system.

8. The method of claim 1, wherein said agent is embedded in a server application.

9. The method of claim 1, wherein said agent comprises functionality to determine quantity and content of any intermediate Web pages between said spoofer's message and said Web page.

10. The method of claim 1, wherein said agent comprises functionality to detect if said Web page contains at least one input field for user credential data.

11. The method of claim 1, wherein said at least one input field is an ID form field or a password field.

12. The method of claim 1, wherein said agent comprises functionality to execute an appropriate course of action, and wherein said method further comprises the step of:
said agent executing an appropriate course of action upon said agent determining said Web page is a spoofed Web page.

13. The method of claim 1, wherein said agent comprises functionality to intercede between a user's action and a spoofed Web page, and wherein said method further comprises the step of:
said agent upon determining said Web page is a spoofed Web page interceding between a user's action and a spoofed Web page.

14. The method of claim 1, further comprising the step of:
said agent communicating with application programming interfaces to any of, or any combination of, said ISP's message application, said Web browser application, and said client application, wherein said communication comprises, but is not limited to, sending commands and obtaining data.

15. The method of claim 1, wherein said spoofer's message is sent via any viable communication protocol, comprising but not limited to email, instant messaging, Web pages, and the like.

16. An apparatus of detecting a spoofed Web page over a network, said apparatus comprising:
means for obtaining a spoofer's message, said spoofer's message containing a hyperlink, which, when clicked opens a Web page within a Web browser;
means for providing an agent for inspecting contextual data associated with said spoofer's message; and
means for said agent using said contextual data for determining whether or not said Web page is a spoofed Web page.

17. The apparatus of claim 16, wherein said contextual data comprises content of said Web page, and sender information and content of said spoofer's message.

18. The apparatus of claim 16, wherein said agent is embedded in a client application, said client application containing said opened Web browser and said message application.

19. The apparatus of claim 16, wherein said agent is embedded in said Web browser.

20. The apparatus of claim 16, wherein said agent is embedded in said message application.

21. The apparatus of claim 16, wherein said agent is a separate client application.

22. The apparatus of claim 16, wherein said agent is embedded in a client operating system.

23. The apparatus of claim 16, wherein said agent is embedded in a server application.

24. The apparatus of claim 16, wherein said agent comprises functionality to determine quantity and content of any intermediate Web pages between said spoofer's message and said Web page.

25. The apparatus of claim 16, wherein said agent comprises functionality to detect if said Web page contains at least one input field for user credential data.

26. The apparatus of claim 16, wherein said at least one input field is an ID field or a password field.

27. The apparatus of claim 16, wherein said agent comprises functionality to execute an appropriate course of action, and wherein said apparatus further comprises:
means for said agent executing an appropriate course of action upon said agent determining said Web page is a spoofed Web page.

28. The apparatus of claim 16, wherein said agent comprises functionality to intercede between a user's action and a spoofed Web page, and wherein said apparatus further comprises:
means for said agent upon determining said Web page is a spoofed Web page interceding between a user's action and a spoofed Web page.

29. The apparatus of claim 16, further comprising:
means for said agent communicating with application programming interfaces to any of, or any combination of, said ISP's message application, said Web browser application, and said client application, wherein said communication comprises, but is not limited to, sending commands and obtaining data.

30. The apparatus of claim 16, wherein said spoofer's message is sent via any viable communication protocol, comprising but not limited to email, instant messaging, Web pages, and the like.

31. A method of capture prevention over a network, said method comprising the steps of:
detecting a Web page is a capture page; and
disarming said capture page to prevent current and/or future user credential capturing.

32. The method of claim 31, said detecting step further comprising any of the steps of:
detecting login ID and password entry by end users;
performing automated contextual analysis of pages; and
performing human analysis of pages.

33. The method of claim 32 wherein said detecting login ID and password entry is by keystroke monitoring.

34. The method of claim 32, said detecting step further comprising the step of:
providing Javascript access to and manipulation of a Web page's Document Object Model for attaching to form fields on Web pages keystroke-monitoring event handlers, said handlers detecting user entry of login ID and/or password.

35. The method of claim 32, said detecting step further comprising the step of:
embedding keystroke monitoring functionality into any of:
a Web browser application associated with said Web page;
a parent client application associated with said Web page;
and a server application associated with said Web page;
wherein said keystroke monitoring functionality comprises event handlers for detecting user entry of login ID and/or password into said Web page.

36. The method of claim 32, said detecting step further comprising the step of:
providing Javascript access to said Web page's Document Object Model to perform spoof-detection analysis on said Web page.

37. The method of claim 32, said detecting step further comprising the step of:
providing access to Web page content from a Web proxy server to perform spoof-detection analysis on said Web page.

38. The method of claim 31, said detecting step further comprising any of or any combination of, but not limited to, the steps of:
determining to which Web pages said detecting step be applied to achieve a predetermined balance between spoof detection and false alarming and performance degradation;
determining whether detecting login ID entry along with other contextual clues obviates need for detecting password entry or whether password entry detection is necessary;
if password detection is necessary, determining how to get a password or a derivative of it to a client for use by an agent; and
determining the correct response when capture is detected.

39. The method of claim 32, said step of performing automated contextual analysis of pages further comprising the steps of:
an agent applying heuristics to score a page's probability of being a capture page; and
said agent taking appropriate actions for said score.

40. The method of claim 39, wherein said appropriate actions comprise any of:
blocking a page's display if said agent has a level of confidence that said page is a spoof page;
sending said page and score to an anti-spoofing manager for further analysis, said further analysis comprising measuring if said score is higher or lower than a predetermined threshold value.

41. The method of claim 32, wherein said automated contextual analysis comprises clues, said clues comprising any of:
determining if the Web page navigated to is from an email hyperlink or, alternatively, how far in terms of links and/or redirects was said Web page from the last email hyperlink;
determining what host is serving said Web page;
determining whether or not there is an obfuscating “userid:password@” prefix before the host name in the URL;
determining whether said Web page contains a form with input elements that could be used for login ID plus password, and
using statistics from end users receiving interactive warnings and/or confirmation dialogs about a page being a possible spoof and are given ability to proceed or cancel.

42. The method of claim 31, wherein said step of disarming said capture page to prevent either of or both of current and future user credential capturing further comprises any of:
blocking or disabling pages;
requesting ISPs and/or site owners to remove pages; and
allowing user to decide if Web pages are spoof pages, said user using an interactive warning and/or confirmation dialog.

43. The method of claim 42, said step of blocking or disabling step further comprising any of:
preventing user access to spoof pages via blocking said spoof pages altogether in a Web proxy server and/or in a client application or a Web browser application by an agent or by disabling said spoof pages;
maintaining an explicit list of URLs to block and blocking only those on said list;
maintaining a list of blocked URL domains or URL regular expressions; and
maintaining a list of allowed domains and/or regular expressions and blocking others.

44. The method of claim 39, wherein said step of allowing user to decide is used when a detection technique's analysis results in an uncertain decision about a given page being a spoof page.

45. The method of claim 39, said step of allowing user to decide further comprises the step of:
an end user explicitly confirming that said page is legitimate before proceeding to open said page or explicitly canceling said page to abort opening the page if the user decides said page is not legitimate.

46. The method of claim 39, said step of allowing user to decide further comprises the step of:
providing statistics of proceed rates and/or abort rates to a page's spoof scoring analysis.

47. An apparatus for capture prevention over a network, said apparatus comprising:
means for detecting a Web page is a capture page; and
means for disarming said capture page to prevent current and/or future user credential capturing.

48. The apparatus of claim 47, said means for detecting further comprising any of:
means for detecting login ID and password entry by end users;
means for performing automated contextual analysis of pages; and
means for performing human analysis of pages.

49. The apparatus of claim 48 wherein said means for detecting login ID and password entry is by keystroke monitoring.

50. The apparatus of claim 48, said means for detecting further comprising:
means for providing Javascript access to and manipulation of a Web page's Document Object Model for attaching to form fields on Web pages keystroke-monitoring event handlers, said handlers detecting user entry of login ID and/or password.

51. The apparatus of claim 48, said detecting step further comprising the step of:
embedding keystroke monitoring functionality into any of:
a Web browser application associated with said Web page;
a parent client application associated with said Web page;
and a server application associated with said Web page;
wherein said keystroke monitoring functionality comprises event handlers for detecting user entry of login ID and/or password into said Web page.

52. The apparatus of claim 48, said detecting step further comprising the step of:
providing Javascript access to said Web page's Document Object Model to perform spoof-detection analysis on said Web page.

53. The apparatus of claim 48, said detecting step further comprising the step of:
providing access to Web page content from a Web proxy server to perform spoof-detection analysis on said Web page.

54. The apparatus of claim 47, said means for detecting further comprising any of:
means for determining to which Web pages said means for detecting be applied to achieve a predetermined balance between spoof detection and false alarming and performance degradation;
means for determining whether detecting login ID entry along with other contextual clues obviates need for detecting password entry or whether password entry detection is necessary;
if password detection is necessary, means for determining how to get a password or a derivative of it to a client for use by an agent; and
means for determining the correct response when capture is detected.

55. The apparatus of claim 48, said means for performing automated contextual analysis of pages further comprising:
means for an agent applying heuristics to score a page's probability of being a capture page; and
means for said agent taking appropriate actions for said score.

56. The apparatus of claim 55, wherein said appropriate actions comprise any of:
blocking a page's display if said agent has a level of confidence that said page is a spoof page;
sending said page and score to an anti-spoofing manager for further analysis, said further analysis comprising measuring if said score is higher or lower than a predetermined threshold value.

57. The apparatus of claim 48, wherein said automated contextual analysis comprises clues, said clues comprising any:
determining if the Web page navigated to is from an email hyperlink or, alternatively, how far in terms of links and/or redirects was said Web page from the last email hyperlink;
determining what host is serving said Web page;
determining whether or not there is an obfuscating “userid:password@” prefix before the host name in the URL;
determining whether said Web page contains a form with input elements that could be used for login ID plus password, and
using statistics from end users receiving interactive warnings and/or confirmation dialogs about a page being a possible spoof and are given ability to proceed or cancel.

58. The apparatus of claim 47, wherein said means for disarming said capture page to prevent either of or both of current and future user credential capturing further comprises any of:
means for blocking or disabling pages;
means for requesting ISPs and/or site owners to remove pages; and
means for allowing user to decide if Web pages are spoof pages, said user using an interactive warning and/or confirmation dialog.

59. The apparatus of claim 58, said means for blocking or disabling further comprising any of:
preventing user access to spoof pages via blocking said spoof pages altogether in a Web proxy server and/or in a client application or a Web browser application by an agent or by disabling said spoof pages;
means for maintaining an explicit list of URLs to block and blocking only those on said list;
means for maintaining a list of blocked URL domains or URL regular expressions; and
means for maintaining a list of allowed domains and/or regular expressions and blocking others.

60. The apparatus of claim 58, wherein said means for allowing user to decide is used when a detection technique's analysis results in an uncertain decision about a given page being a spoof page.

61. The apparatus of claim 58, said means for allowing user to decide further comprises:
means for an end user explicitly confirming that said page is legitimate before proceeding to open said page or explicitly canceling said page to abort opening the page if the user decides said page is not legitimate.

62. The apparatus of claim 58, said means for allowing user to decide further comprises:
means for providing statistics of proceed rates and/or abort rates to a page's spoof scoring analysis.

63. An agent for detecting and blocking spoofed Web pages, said agent comprising:
means for receiving notification by a Web browser when a new Web page having a Document Object Model is loaded into said Web browser;
means for accessing said Document Object Model;
means for modifying said Document Object;
means for accessing other context in said Web browser, said other context comprising URL history, a user's cookies, and the like; and
means for accessing navigation requests made to said Web browser; and
means for overriding navigation requests made to said Web browser.

64. A method for an agent to detect and block spoofed Web pages, said method comprising the steps of:
receiving notification by a Web browser when a new Web page having a Document Object Model is loaded into said Web browser;
accessing said Document Object Model;
modifying said Document Object Model when necessary;
accessing other context in said Web browser, said other context comprising URL history, a user's cookies, and the like;
accessing navigation requests made to said Web browser; and
overriding navigation requests made to said Web browser when necessary.
